(19) United States
(12) Patent Application Publication
(10) Pub. No.: US 2023/0169367 A1
(43) Pub. Date: Jun. 1, 2023

(54) SYSTEMS AND METHODS FOR PREDICTING A TARGET EVENT ASSOCIATED WITH A MACHINE

(71) Applicant: Caterpillar Inc., Peoria, IL (US)

(72) Inventor: Anshu Srivastava, Tucson, AZ (US)

(21) Appl. No.: 17/539,542

(22) Filed: Dec. 1, 2021

(51) Int. Cl. G06N 5/04; G06F 16/2458; G06N 20/00

(52) U.S. Cl. CPC G06N 5/04; G06F 16/2474; G06N 20/00

(57) ABSTRACT

A method for predicting a target event associated with a machine can include receiving sequential event data for multiple machines, wherein the event data comprises telematics data received from sensors on each of the multiple machines. The method includes identifying a target event and generating event sequences for each machine, including: identifying each occurrence of the target event in the event data, generating an event sequence for each occurrence of the target event, comprising events preceding the target event, and storing the event sequences in a database. The method includes identifying rules corresponding to the target event. Telematics data from sensors on multiple deployed machines can be received and the rules are applied to the received telematics data to identify a deployed machine with telematics event data that satisfies at least one rule. The method includes indicating a likelihood that the identified deployed machine will experience the target event.

### TECHNICAL FIELD

This patent application is directed to predicting events, and more specifically, to predicting events associated with a machine.

### BACKGROUND

Accurately predicting events associated with machines or equipment is an important business problem that can have an impact on resource allocation and machine downtime which in turn impacts customer satisfaction, for example. Predicting replacement part sales is useful for estimating capital costs involved in manufacturing and storage of parts by geographic region. Predicting component failures and machine downtime can provide an opportunity to address the potential failure to reduce any associated downtime as much as possible.

U.S. Patent Application Publication No. 2018/0218269 to Oliner et al., (hereinafter “Oliner”) is directed to predicting target events in raw machine data produced by components within an information technology or security environment. Oliner predicts a target event by identifying leading indicators to the target event based on the existence of a condition that exists in a search window of time but not present in a control window of time prior to the search window or vice versa.

While Oliner can identify events in components of an information technology or security environment, Oliner is not directed to predicting component failures and machine downtime. Furthermore, Oliner requires a search window and a control window to identify distinguishing data, e.g., number of memory errors, which may be unnecessarily complex for evaluating equipment. Thus, there are still opportunities to improve accurately predicting events associated with machines or equipment. The example systems and methods described herein are directed to overcoming one or more of the deficiencies described above and/or other problems with the prior art.

### SUMMARY

In some embodiments, a method for predicting a target event associated with a machine can include receiving sequential event data for each of a plurality of machines, wherein the sequential event data comprises telematics event data received from sensors on each of the plurality of machines. The method can include identifying a target event of interest and generating one or more event sequences for each machine, including: identifying each occurrence of the target event in the sequential event data corresponding to each machine, generating an event sequence for each occurrence of the target event, comprising a plurality of events preceding the occurrence of the target event, and storing the one or more event sequences in a sequence database. The method can also include analyzing the event sequences in the sequence database to identify one or more rules corresponding to the target event. Telematics event data from sensors on a plurality of deployed machines is received and the one or more rules can be applied to the received telematics event data for each of the plurality of deployed machines to identify at least one deployed machine with telematics event data that satisfies at least one of the one or more rules. The method can include indicating to a user a likelihood that the identified at least one deployed machine will experience the target event.

In some aspects, the sequential event data comprises part sales event data for each machine and wherein the target event is a part sales event. In further aspects, the target event is a machine fault code. In other aspects, at least some of the event sequences comprise all events prior to the target event occurrence, up to but not including any previous occurrence of the target event. In still further aspects, the sequential event data includes an event identifier and an associated timestamp for each event. In some aspects, at least one of the rules includes a list of events that precede the target event. In some aspects, the method can further comprise calculating a time period between each event that precedes the target event, wherein the likelihood that the identified at least one deployed machine will experience the target event is based on the calculated time periods.

In some embodiments, a system for predicting a target event associated with a machine can include one or more processors and one or more memory devices having instructions stored thereon. When executed, the instructions cause the processors to receive sequential event data for each of a plurality of machines, wherein the sequential event data comprises telematics event data received from sensors on each of the plurality of machines. The instructions can also cause the processors to identify a target event of interest and generate one or more event sequences for each machine, including: identifying each occurrence of the target event in the sequential event data corresponding to each machine, generating an event sequence for each occurrence of the target event, comprising a plurality of events preceding the occurrence of the target event, and storing the one or more event sequences in a sequence database. The instructions can cause the processors to analyze the event sequences in the sequence database to identify one or more rules corresponding to the target event. Telematics event data from sensors on a plurality of deployed machines is received and the one or more rules can be applied to the received telematics event data for each of the plurality of deployed machines to identify at least one deployed machine with telematics event data that satisfies at least one of the one or more rules. The instructions can cause the processors to indicate to a user a likelihood that the identified at least one deployed machine will experience the target event.

In some embodiments, one or more non-transitory computer-readable media can store computer-executable instructions that, when executed by one or more processors, cause the one or more processors to perform operations. The operations can include receiving sequential event data for each of a plurality of machines, wherein the sequential event data comprises telematics event data received from sensors on each of the plurality of machines. The operations can also include identifying a target event of interest and generating one or more event sequences for each machine, including: identifying each occurrence of the target event in the sequential event data corresponding to each machine, generating an event sequence for each occurrence of the target event, comprising a plurality of events preceding the occurrence of the target event, and storing the one or more event sequences in a sequence database. The operations can also include analyzing the event sequences in the sequence database to identify one or more rules corresponding to the target event. Telematics event data from sensors on a plurality of deployed machines is received and the one or more rules can be applied to the received telematics event data for each of the plurality of deployed machines to identify at least one deployed machine with telematics event data that satisfies at least one of the one or more rules. The operations can also include indicating to a user a likelihood that the identified at least one deployed machine will experience the target event.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 is a diagram illustrating an overview of an environment in which some implementations can operate according to embodiments of the disclosed technology;

FIG. 2 is a block diagram illustrating an overview of a target event prediction system according to some embodiments of the disclosed technology;

FIG. 3 is a diagram illustrating the sequenced data relating to multiple machines according to embodiments of the disclosed technology;

FIG. 4 is a table illustrating representative predictor events for a target event according to some embodiments of the disclosed technology;

FIG. 5 is a table illustrating representative event data for multiple machines according to some embodiments of the disclosed technology;

FIG. 6 is a flow diagram showing a method for predicting a target event associated with a machine according to some embodiments of the disclosed technology;

FIG. 7 is a block diagram illustrating an overview of devices on which some implementations can operate;

FIG. 8 is a block diagram illustrating an overview of an environment in which some implementations can operate; and

FIG. 9 is a block diagram illustrating components which, in some implementations, can be used in a system employing the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all suitable modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

Disclosed are methods and systems for predicting significant target events from a business perspective, for example. These methods and systems provide analytic approaches that go beyond traditional reporting tools. The disclosed technology provides advanced predictive and prescriptive tools that can identify patterns in historical data sets, identify sequences (chain of events in time or co-occurrences in transactions) that precede an outcome, event or transaction, and generate rules to predict outcomes with certain probability, prescribe actions, and evaluate options for a targeted business objective.

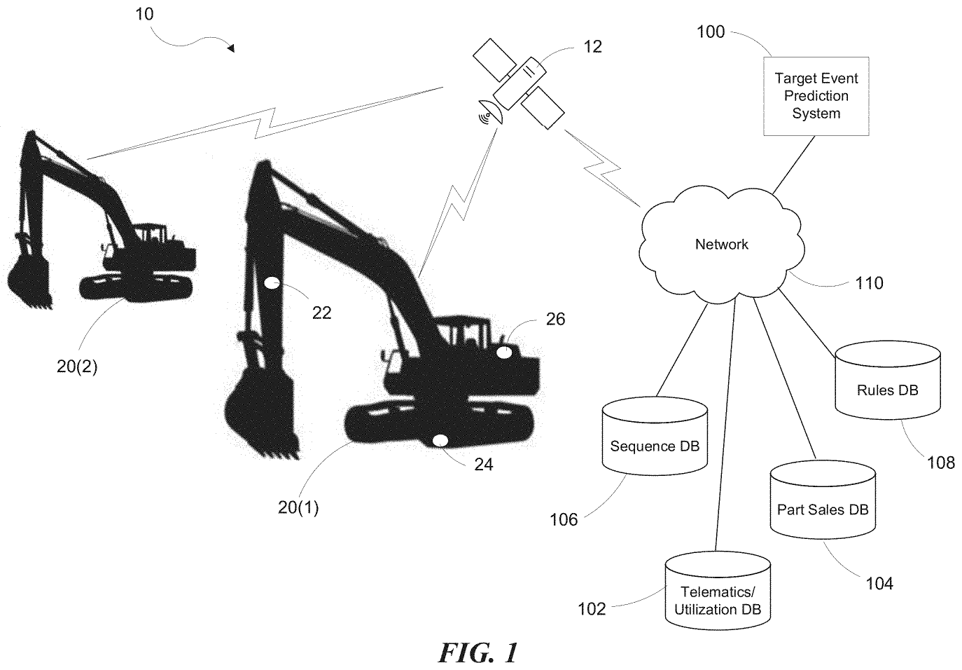

FIG. 1 illustrates an environment 10 in which some implementations of the target event prediction system 100 can operate according to embodiments of the disclosed technology. The system environment 10 can include multiple machines, such as excavators 20(1) and 20(2), a satellite 12, telematics database 102, a part sales database 104, sequence database 106, a rules database 108, and a network 110. The target event prediction system 100 can be connected to the telematics database 102, the part sales database 104, the sequence database 106, and the rules database 108 via network 110. The telematics database 102 and the target event prediction system 100 can receive telematics data from the excavators 20(1) and 20(2) via satellite 12. Cell radio, wifi, Bluetooth®, etc. are additional examples of suitable data transmission modes. The telematics data can include events, diagnostic, and sensor data from the excavators, such as from a pressure sensor 22, a vibration sensor 24, and a temperature sensor 26, to name a few.

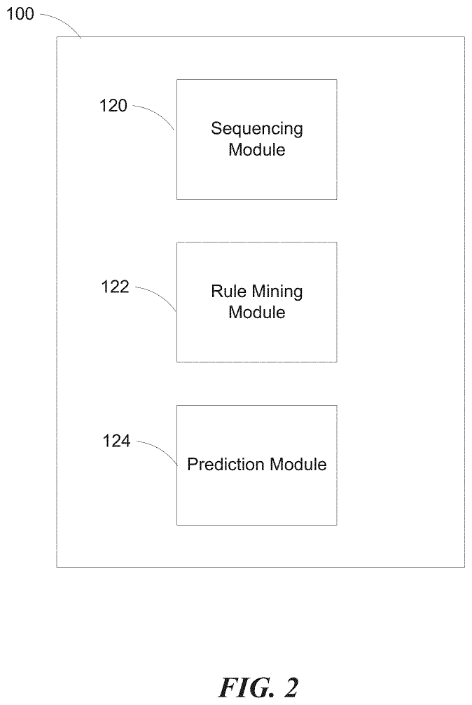

As shown in FIG. 2, the target event prediction system 100 can comprise a Sequencing module 120, a Rule Mining module 122, and a Prediction module 124. In some embodiments, the Sequencing module 120 receives data from various sources and removes any data without codes or identifiers. The data selected in the sequence can be multiparameter, i.e., from different source databases, different tables, and the data type can be different from the data type of the target event. A target event, identified by a code or other identifier, is selected based on a business problem to be solved. For example, it may be advantageous to predict an engine overhaul event which can be identified with a particular event code. As another example, a sequence ending in a new part purchase order (transactional data), can be preceded with data from machine fault codes (telematics IoT data) in the same sequence. The Sequencing module 120 can check for unique occurrences of the target event in the dataset. Module 120 generates the sequences database 106 including each instance of the target event. The target event is used as the end point of a unique sequence. Multiple sequences together form the sequence database. In some embodiments, each sequence can include all event codes prior to the target event occurrence, up to but not including the last seen occurrence of the target event. In some embodiments, each sequence can be limited to a time window or fixed number of data points prior to the target event.

In some embodiments, Rule Mining module 122 uses the generated sequences database as an input. Module 122 can be configured to use a suitable data mining algorithm, such as an Apriori algorithm. Some specific Python library names for such algorithms are Scikit-learn and MLxtend, for example. The results from such an algorithm can be rules showing the most frequently occurring antecedents, support, and confidence. Antecedents (features or predictors) are the events that were seen prior to the consequent (target event) in the sequence database. Support indicates count of sequences where the rule was seen, with a given confidence. There are many other algorithms variations that can be run on the generated sequence database to generate different output results. The formatting of the sequence database can be changed per the requirements of the data mining algorithm, for example converting all values to ‘strings’, adding special delimiters to separate individual sequences, such formatted data can also be exported in different file types .csv, .text, etc. as needed for the selected data mining algorithm. In some embodiments, the sequence generation scripts can be written in Python. The sequence database can be passed as an input to the sequence algorithm using separately created libraries or Python wrappers to invoke the underlying mining algorithm that may be written in Java or other languages, or to invoke executable files.

In some embodiments, Prediction module 124 can be configured to receive e.g., telematics event data from sensors on a plurality of deployed machines. Module 124 can be configured to apply the one or more rules from the Rule Mining module 122, or rule database 108, to the received telematics event data for each of the plurality of deployed machines to identify deployed machines with telematics event data that satisfies the one or more rules. Prediction module 124 can also indicate to a user a likelihood that the identified at least one deployed machine will experience the target event.

The above-mentioned processes can be performed on a local computer/server hardware e.g., on the machine, or on a cloud hosted infrastructure like AWS, Snowflake, etc. and using API's. The processes can be executed as a single job, a scheduled batch job, or on real-time streaming data. When the target event prediction system 100 is implemented on-board a machine, the Sequencing module 120 operations and Rule Mining module 122 operations are performed in the cloud/back office to create the trained prediction model 124. On-board the machine, real time event data from the machine can be fed to the prediction module 124 to predict the likelihood of target events and associated time periods.

The user interface of such an application can be built according to business needs and can be hosted locally or via a browser or device apps. The application can be stand alone or using microservice architecture and API's can be leveraged or integrated into other existing business applications, for example.

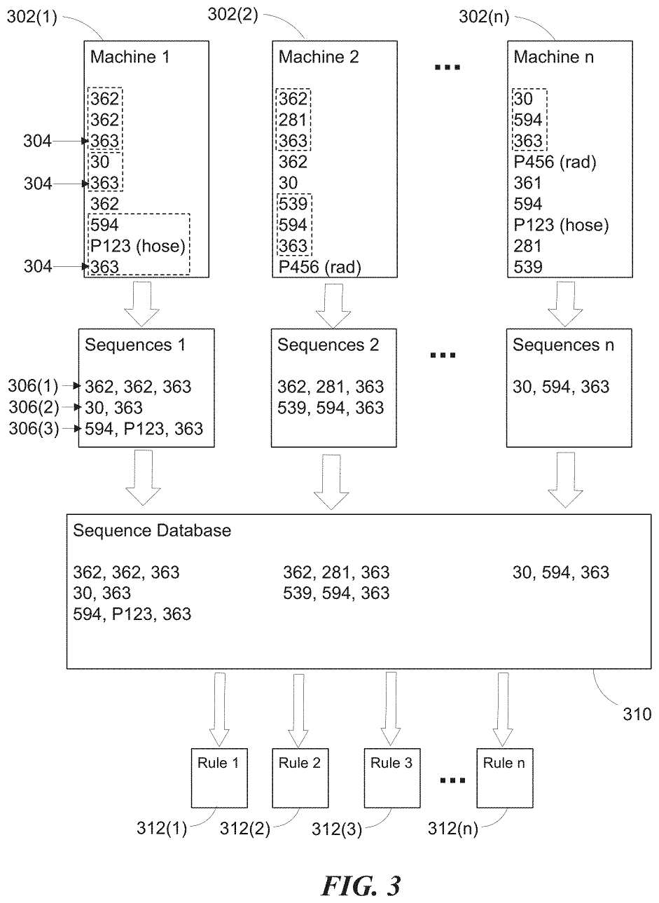

FIG. 3 is a diagram illustrating sequential data 302 relating to multiple machines according to embodiments of the disclosed technology. Each machine (e.g., Machines 1-n) can have associated sequential data 302(1)-302(n). A set of sequences (e.g., sequences sets 1-n) can be generated for each corresponding machine. In this example, the target event 304 is event code 363, which corresponds to a Shut-Down Engine Coolant Temperature event. In some embodiments, at least some of the event sequences (e.g., sequences 306(1) and 306(2)) comprise all events prior to the target event occurrence, up to but not including any previous occurrence of the target event. In some embodiments, the sequences are limited to a maximum number of events (e.g., two events) prior to the target event (e.g., sequence 306(3)). In some embodiments, the sequences are limited to events that occur within a time interval. The sequences (e.g., Sequence sets 1-n) are stored in a sequence database 310. A suitable data mining algorithm generates rules, e.g., Rules 312(1)-(n), that can be applied to sequential data associated with one or more machines of interest (e.g., deployed machines) to predict target events.

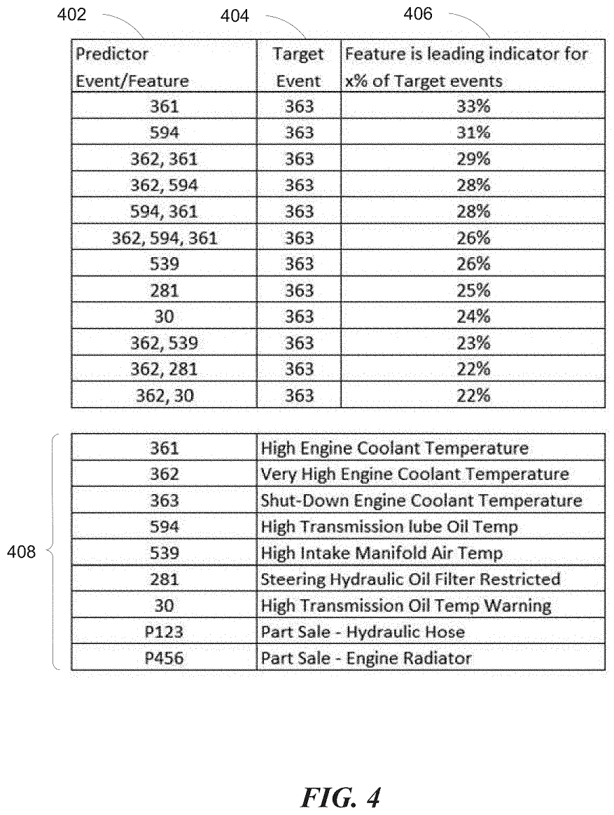

FIG. 4 is a table illustrating representative predictor events 402, e.g., rules, for a target event 404 (i.e., code 363) according to some embodiments of the disclosed technology. The target events 404 are all the same in this example to illustrate different predictor events and combinations of events. Each predictor event 402 is a leading indicator for x % of target events 404 as shown in column 406. Code list 408 provides a description of each predictor event/feature code.

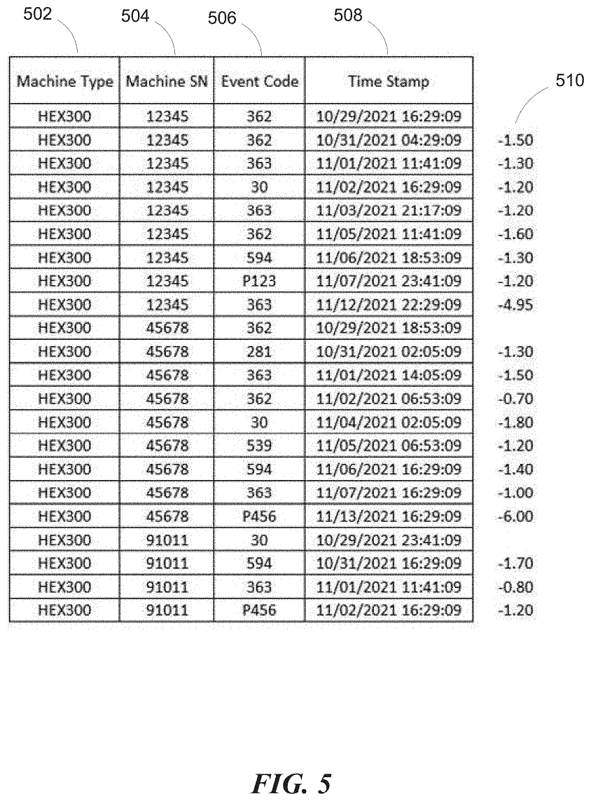

FIG. 5 is a table illustrating representative event data for multiple machines according to some embodiments of the disclosed technology. The event data can include machine type 502 and a unique machine identifier, such as a machine serial number 504. The sequential event data can include an event identifier/code 506 and an associated timestamp 508 for each event. In some embodiments, a time period 510 between each event that precedes the target event is calculated. The likelihood that the machine associated with the sequential data will experience the target event can be based, at least in part, on the calculated time periods 510. In some embodiments, the likelihood that the machine associated with the sequential data will experience the target event can be based on the order of events preceding the target event. The data selected in the sequence can be multiparameter, from different source databases, different tables, and also the data type can be different from the data type of the target event. For example, a sequence ending in a new part purchase order (transactional data), can be preceded with data from machine fault codes (telematics IoT data) in the same sequence. In some embodiments, the sequential event data comprises part sales event data for each machine and wherein the target event is a part sales event.

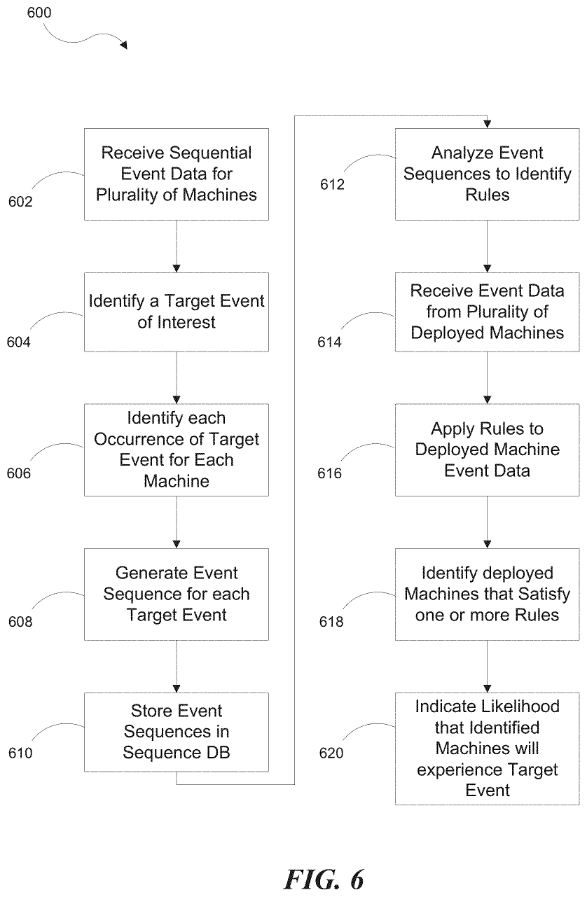

FIG. 6 is a flow diagram showing a method 600 for predicting a target event associated with a machine according to some embodiments of the disclosed technology. The method 600 can include receiving sequential event data for each of a plurality of machines at step 602. The sequential event data can comprise telematics event data received from sensors on each of the plurality of machines, for example. At step 604 a target event of interest is identified, based on a business objective, for example. One or more event sequences are generated for each machine, including: at step 606, identifying each occurrence of the target event in the sequential event data corresponding to each machine and generating an event sequence for each occurrence of the target event at step 608. In some embodiments, each event sequence can comprise a plurality of events preceding the occurrence of the target event. At step 610, the one or more event sequences are stored in a sequence database. At step 612, the event sequences in the sequence database are analyzed to identify one or more rules corresponding to the target event. For example, at least one of the rules can include a list of events that precede the target event.

In some embodiments, event data, such as telematics data, can be received from sensors on a plurality of deployed machines at step 614. At step 616, the one or more rules are applied to the received telematics event data for each of the plurality of deployed machines to identify, at step 618, at least one deployed machine with telematics event data that satisfies at least one of the one or more rules. The likelihood that the identified at least one deployed machine will experience the target event is communicated to a user at step 620 via a suitable user interface. In some embodiments, the likelihood that the target event will occur within a certain time period can be determined.

The user interface can be built according to business needs and can be hosted locally or via a browser or device apps. The application can be stand alone or use a microservice architecture and API's can be leveraged or integrated into other existing business applications. The prediction results can be presented on-board the machine/device, in back office applications or a device browser/apps. In some embodiments, the event prediction results may be used as an input into the control system of the machine/business system to trigger necessary actions/workflows.

In some embodiments, the above described steps can be performed on-board the machine or device, or on a local computer/server hardware, or cloud hosted infrastructure. The disclosed processes can be executed as a single job, a scheduled batch job, or on real-time streaming data. Pre-trained sequence mining algorithms/Machine Learning models can be embedded into the machine, and preform inference/predictions on-board the machine on real time events data.

### Suitable System

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

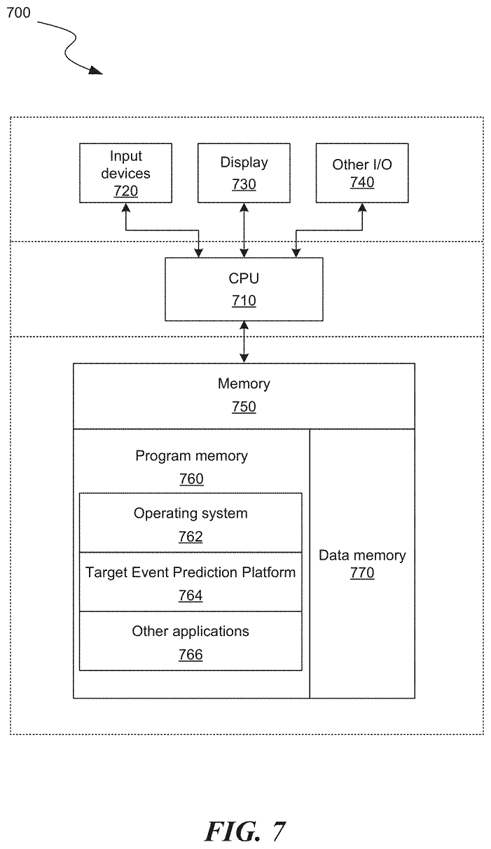

Several implementations are discussed below in more detail in reference to the figures. FIG. 7 is a block diagram illustrating an overview of devices on which some implementations of the disclosed technology can operate. The devices can comprise hardware components of a device 700 that performs target event prediction, for example. Device 700 can include one or more input devices 720 that provide input to the CPU (processor) 710, notifying it of actions. The actions are typically mediated by a hardware controller that interprets the signals received from the input device and communicates the information to the CPU 710 using a communication protocol. Input devices 720 include, for example, sensors, a mouse, a keyboard, a touchscreen, an infrared sensor, a touchpad, a wearable input device, a camera- or image-based input device, a microphone, or other user input devices.

CPU 710 can be a single processing unit or multiple processing units in a device or distributed across multiple devices. CPU 710 can be coupled to other hardware devices, for example, with the use of a bus, such as a PCI bus or SCSI bus. The CPU 710 can communicate with a hardware controller for devices, such as for a display 730. Display 730 can be used to display text and graphics. In some examples, display 730 provides graphical and textual visual feedback to a user. In some implementations, display 730 includes the input device as part of the display, such as when the input device is a touchscreen or is equipped with an eye direction monitoring system. In some implementations, the display is separate from the input device. Examples of display devices are: an LCD display screen; an LED display screen; a projected, holographic, or augmented reality display (such as a heads-up display device or a head-mounted device); and so on. Other I/O devices 740 can also be coupled to the processor, such as a network card, video card, audio card, USB, FireWire or other external device, sensor, camera, printer, speakers, CD-ROM drive, DVD drive, disk drive, or Blu-Ray device.

In some implementations, the device 700 also includes a communication device capable of communicating wirelessly or wire-based with a network node. The communication device can communicate with another device or a server through a network using, for example, TCP/IP protocols. Device 700 can utilize the communication device to distribute operations across multiple network devices.

The CPU 710 can have access to a memory 750. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 750 can include program memory 760 that stores programs and software, such as an operating system 762, Target Event Prediction Platform 764, and other application programs 766. Memory 750 can also include data memory 770 that can include database information, etc., which can be provided to the program memory 760 or any element of the device 700.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, programmable consumer electronics, network PCs, minicomputers, mainframe computers, IoT devices, on-board microcontrollers, edge computing devices, distributed computing environments and/or cloud platforms that include any of the above systems or devices, or the like.

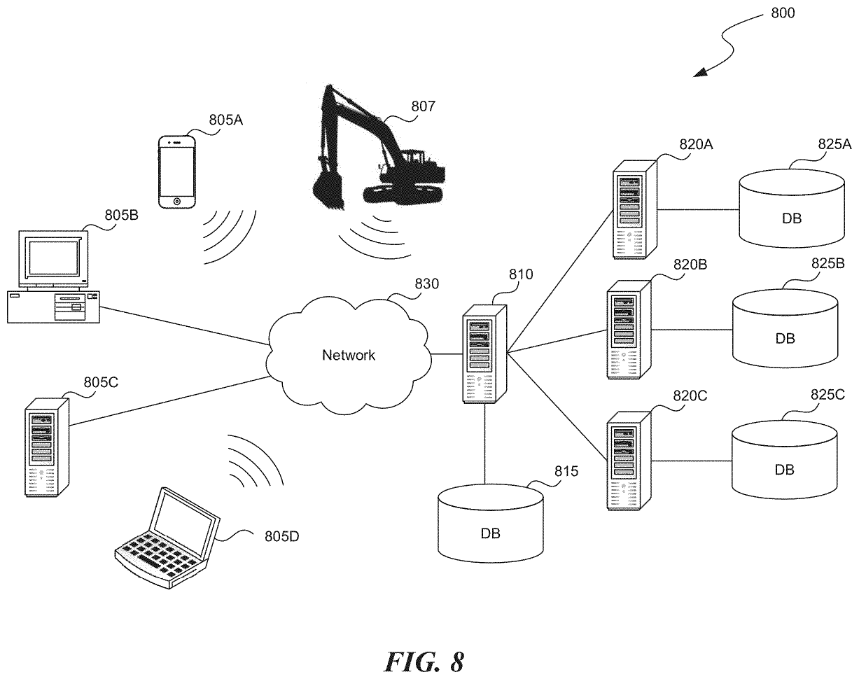

FIG. 8 is a block diagram illustrating an overview of an environment 800 in which some implementations of the disclosed technology can operate. Environment 800 can include one or more client computing devices 805A-D, examples of which can include device 700. Environment 800 can also include one or more machines 807. Client computing devices 805 and machines 807 can operate in a networked environment using logical connections through network 830 to one or more remote computers, such as a server computing device 810.

In some implementations, server computing device 810 can be an edge server that receives client requests and coordinates fulfillment of those requests through other servers, such as servers 820A-C. Server computing devices 810 and 820 can comprise computing systems, such as device 700. Though each server computing device 810 and 820 is displayed logically as a single server, server computing devices can each be a distributed computing environment encompassing multiple computing devices located at the same or at geographically disparate physical locations. In some implementations, each server computing device 820 corresponds to a group of servers.

Client computing devices 805 and server computing devices 810 and 820 can each act as a server or client to other server/client devices. Server 810 can connect to a database 815. Servers 820A-C can each connect to a corresponding database 825A-C. As discussed above, each server 820 can correspond to a group of servers, and each of these servers can share a database or can have their own database. Databases 815 and 825 can warehouse (e.g., store) information. Though databases 815 and 825 are displayed logically as single units, databases 815 and 825 can each be a distributed computing environment encompassing multiple computing devices, can be located within their corresponding server, or can be located at the same or at geographically disparate physical locations.

Network 830 can be a local area network (LAN) or a wide area network (WAN), but can also be other wired or wireless networks. Network 830 may be the Internet or some other public or private network. Client computing devices 805 can be connected to network 830 through a network interface, such as by wired or wireless communication. While the connections between server 810 and servers 820 are shown as separate connections, these connections can be any kind of local, wide area, wired, or wireless network, including network 830 or a separate public or private network.

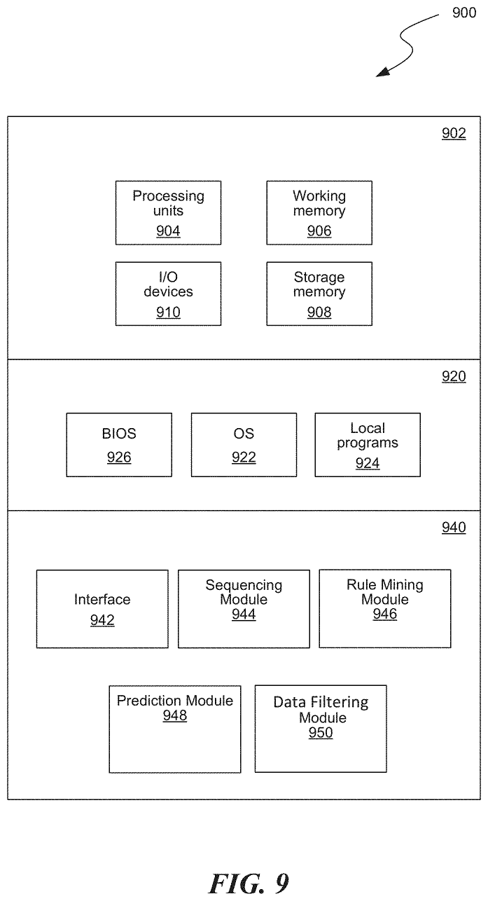

FIG. 9 is a block diagram illustrating components 900 which, in some implementations, can be used in a system employing the disclosed technology. The components 900 include hardware 902, general software 920, and specialized components 940. As discussed above, a system implementing the disclosed technology can use various hardware, including processing units 904 (e.g., CPUs, GPUs, APUs, etc.), working memory 906, storage memory 908, and input and output devices 910. Components 900 can be implemented in a client computing device such as client computing devices 805 or on a server computing device, such as server computing device 810 or 820.

General software 920 can include various applications, including an operating system 922, local programs 924, and a basic input output system (BIOS) 926. Specialized components 940 can be subcomponents of a general software application 920, such as local programs 924. Specialized components 940 can include a Sequencing Module 944, an Rule Mining Module 946, a Prediction Module 948, a Data Filtering Module 950, and components that can be used for transferring data and controlling the specialized components, such as Interface 942. In some implementations, components 900 can be in a computing system that is distributed across multiple computing devices or can be an interface to a server-based application executing one or more of specialized components 940.

Those skilled in the art will appreciate that the components illustrated in FIGS. 7-9 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described herein.

### INDUSTRIAL APPLICABILITY

In some embodiments, a target event prediction system can include a Sequencing Module 944, a Rule Mining Module 946, a Prediction Module 948, and a Data Filtering Module 950 (FIG. 9). In operation, the Sequencing Module 944 can receive sequential event data for each of a plurality of machines, e.g., 20(1) and 20(2), from the Data Filtering Module 950 after any data without codes or identifiers is removed. The sequential event data can comprise telematics event data received from sensors (e.g., 22, 24, and 26) on each of the plurality of machines or from the telematics database 102, sales data from the Part Sales database 104, and other data associated with the machines. Module 944 identifies a target event of interest, based on a business objective, for example. One or more event sequences are then generated for each machine, including: identifying each occurrence of the target event in the sequential event data corresponding to each machine and generating an event sequence for each occurrence of the target event. The one or more event sequences are stored in the sequence database 106.

The Rule Mining Module 946 can analyze the event sequences in the sequence database 106 using suitable algorithms to identify one or more rules corresponding to the target event. For example, at least one of the rules can include a list of events that precede the target event. The rules can be stored in the rules database 108, for example.

The Prediction Module 948 can receive event data, such as telematics data, from sensors on a plurality of deployed machines. The one or more rules are applied to the received telematics event data for each of the plurality of deployed machines to identify at least one deployed machine with telematics event data that satisfies at least one of the one or more rules. The likelihood that the identified at least one deployed machine will experience the target event is communicated to a user via a suitable user interface. In some embodiments, the likelihood that the target event will occur within a certain time period can be determined.

Some examples of additional use cases can include machine condition monitoring using machine telematics data, events and diagnostics, machine downtime events, component failures, oil sample results, inspections, operator inputs and interaction with machine, service and maintenance performed on machines, parts removed, added, repaired, rebuilt, or remanufactured, machine troubleshooting, spare parts orders, consumables orders, maintenance backlog, work orders, and repair history.

Other use cases can include machine and part sales using invoices, new machine sales orders, rental machine sales, service parts sales, machine financing, insurance, customer value agreements, contracts, marketing leads, service events leads, customer interactions, customer relationship management, in person and online leads and sales. Engineering data can also be used in sequences. For example, part or assembly, bill of materials, product hierarchy, product lifecycle management, design/build/test/simulation/validation, and new product introduction, including digital products and service and solutions products. Use cases also include manufacturing and supply chain data, such as demand signals, forecasts, orders on suppliers, deliveries from suppliers, quality metrics, invoices, parts received, production planning, enterprise resource planning, assembly line data, machine tool and production line data including sensor data for condition monitoring, manufacturing plan, production, backlog, quality data, and facility maintenance and planning. Human resources information can provide additional use cases, which can include safety, workforce hiring, performance management, attrition, career progression, compensation and benefits, training and development, talent pipeline, regulatory compliance. Corporate data can be used as well, including data related to strategy, business development, finance, accounting, investments, legal, investor relations, and regulatory compliance.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way. Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A method for predicting a target event associated with a machine, the method comprising:
receiving sequential event data for each of a plurality of machines, wherein the sequential event data comprises telematics event data received from sensors on each of the plurality of machines;
identifying a target event of interest;
generating one or more event sequences for each machine, including:
identifying each occurrence of the target event in the sequential event data corresponding to each machine;
generating an event sequence for each occurrence of the target event, comprising a plurality of events preceding the occurrence of the target event; and
storing the one or more event sequences in a sequence database;
analyzing the event sequences in the sequence database to identify one or more rules corresponding to the target event;
receiving telematics event data from sensors on a plurality of deployed machines;
applying the one or more rules to the received telematics event data for each of the plurality of deployed machines to identify at least one deployed machine with telematics event data that satisfies at least one of the one or more rules; and
indicating to a user a likelihood that the identified at least one deployed machine will experience the target event.

2. The method of claim 1, wherein the sequential event data comprises part sales event data for each machine and wherein the target event is a part sales event.

3. The method of claim 1, wherein the sequential event data comprises a combination of multiple data types and data sources.

4. The method of claim 1, wherein at least some of the event sequences comprise all events prior to the target event occurrence, up to but not including any previous occurrence of the target event.

5. The method of claim 1, wherein the sequential event data includes an event identifier and an associated timestamp for each event.

6. The method of claim 1, wherein at least one of the rules includes a list of events that precede the target event.

7. The method of claim 6, further comprising calculating a time period between each event that precedes the target event, wherein the likelihood that the identified at least one deployed machine will experience the target event is based on the calculated time periods.

8. A system for predicting a target event associated with a machine, the system comprising:
one or more processors; and
one or more memory devices having stored thereon instructions that when executed by the one or more processors cause the one or more processors to:
receive sequential event data for each of a plurality of machines, wherein the sequential event data comprises telematics event data received from sensors on each of the plurality of machines;
identify a target event of interest;
generate one or more event sequences for each machine, including:
identifying each occurrence of the target event in the sequential event data corresponding to each machine;
generating an event sequence for each occurrence of the target event, comprising a plurality of events preceding the occurrence of the target event; and
storing the one or more event sequences in a sequence database;
analyze the event sequences in the sequence database to identify one or more rules corresponding to the target event;
receive telematics event data from sensors on a plurality of deployed machines;
apply the one or more rules to the received telematics event data for each of the plurality of deployed machines to identify at least one deployed machine with telematics event data that satisfies at least one of the one or more rules; and
indicate to a user a likelihood that the identified at least one deployed machine will experience the target event.

9. The system of claim 8, wherein the sequential event data comprises part sales event data for each machine and wherein the target event is a part sales event.

10. The system of claim 8, wherein the target event is a machine fault code.

11. The system of claim 8, wherein at least some of the event sequences comprise all events prior to the target event occurrence, up to but not including any previous occurrence of the target event.

12. The system of claim 8, wherein the sequential event data includes an event identifier and an associated timestamp for each event.

13. The system of claim 8, wherein at least one of the rules includes a list of events that precede the target event.

14. The system of claim 13, further comprising instructions to calculate a time period between each event that precedes the target event, wherein the likelihood that the identified at least one deployed machine will experience the target event is based on the calculated time periods.

15. One or more non-transitory computer-readable media storing computer-executable instructions that, when executed by one or more processors, cause the one or more processors to perform operations comprising:
receiving sequential event data for each of a plurality of machines, wherein the sequential event data comprises telematics event data received from sensors on each of the plurality of machines;
identifying a target event of interest;
generating one or more event sequences for each machine, including:
identifying each occurrence of the target event in the sequential event data corresponding to each machine;
generating an event sequence for each occurrence of the target event, comprising a plurality of events preceding the occurrence of the target event; and
storing the one or more event sequences in a sequence database;
analyzing the event sequences in the sequence database to identify one or more rules corresponding to the target event;
receiving telematics event data from sensors on a plurality of deployed machines;
applying the one or more rules to the received telematics event data for each of the plurality of deployed machines to identify at least one deployed machine with telematics event data that satisfies at least one of the one or more rules; and
indicating to a user a likelihood that the identified at least one deployed machine will experience the target event.

16. The one or more non-transitory computer-readable media of claim 15, wherein the sequential event data comprises part sales event data for each machine and wherein the target event is a part sales event.

17. The one or more non-transitory computer-readable media of claim 15, wherein at least some of the event sequences comprise all events prior to the target event occurrence, up to but not including any previous occurrence of the target event.

18. The one or more non-transitory computer-readable media of claim 15, wherein the sequential event data includes an event identifier and an associated timestamp for each event.

19. The one or more non-transitory computer-readable media of claim 15, wherein at least one of the rules includes a list of events that precede the target event.

20. The one or more non-transitory computer-readable media of claim 19, further comprising calculating a time period between each event that precedes the target event, wherein the likelihood that the identified at least one deployed machine will experience the target event is based on the calculated time periods.
